(19) United States
(12) Patent Application Publication
(10) Pub. No.: US 2025/0113070 A1
(43) Pub. Date: Apr. 3, 2025

(54) SYSTEMS AND METHODS FOR CLOUD-BASED DIGITAL AUDIO AND VIDEO PROCESSING

(71) Applicant: Harman International Industries, Incorporated, Stamford, CT (US)

(72) Inventor: Victor Kalinichenko, Putzbrunn (DE)

(21) Appl. No.: 18/832,896

(22) PCT Filed: Jan. 24, 2022
(86) PCT No.: PCT/US2022/070325

§ 371 Date: Jul. 24, 2024

(51) Int. Cl. H04N 21/2343; H04N 21/414

(52) U.S. Cl. CPC H04N 21/23439; H04N 21/41422

(57) ABSTRACT

Embodiments for on-demand processing of audiovisual data are provided. In one example, a method for on-demand audiovisual (AV) data processing for playback in a vehicle includes pre-processing, with a local digital signal processor of the vehicle, an AV data file, the pre-processing including forming a plurality of digital AV signals from the AV data file, sending at least a portion of the plurality of digital AV signals to a cloud-based server configured to apply one or more processing features to the at least the portion of the plurality of digital AV signals, receiving processed versions of the at least the portion of the plurality of digital AV signals from the cloud-based server, and outputting the processed versions of the at least the portion of the plurality of digital AV signals to one or more AV sinks of the vehicle.

### FIELD The disclosure relates to the field of in-vehicle audio and video systems.

### BACKGROUND

Some motor vehicles may include in-vehicle entertainment systems, such as media players and radios. These vehicle entertainment systems may be used to deliver media such as audio and video content to the operator and/or passengers of the vehicle. Media may be sourced from radio signals (e.g. frequency-modulated, FM), external devices (e.g. mobile phones), or a multitude of other sources. To improve the listening and/or viewing experience, digital signal processing may be employed to adjust a quality of the audio and/or video. Digital signal processing may add desirable audio and video effects in order to suit the preferences of the end user. Digitally processed (or unprocessed) signals may be played using the vehicle's internal audio system, e.g. using speakers and/or video screens.

### SUMMARY

In various embodiments, the issues described above may be addressed by method for on-demand audiovisual (AV) data processing for playback in a vehicle, comprising pre-processing, with a local digital signal processor of the vehicle, an AV data file, the pre-processing including forming a plurality of digital AV signals from the AV data file, sending at least a portion of the plurality of digital AV signals to a cloud-based server configured to apply one or more processing features in real-time or in non-real-time to the at least the portion of the plurality of digital AV signals, receiving processed versions of the at least the portion of the plurality of digital AV signals from the cloud-based server, and outputting the processed versions of the at least the portion of the plurality of digital AV signals to one or more AV sinks of the vehicle.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows an example partial view of a vehicle cabin in accordance with one or more embodiments of the present disclosure;

FIG. 2 shows a block diagram of an example in-vehicle computing system of a vehicle with a digital media player, in accordance with one or more embodiments of the present disclosure;

FIG. 3 shows a block diagram of an example car audio/video system;

FIG. 4 shows a block diagram of an example of a car multimedia system;

FIG. 5 shows a block diagram of cross-morphing of a multi-channel locally processed digital signal processing signal and a multi-channel cloud processing signal;

FIG. 6 shows a block diagram of cloud-based signal processing, in accordance with one or more embodiments of the present disclosure;

FIG. 7 shows a method for performing digital signal processing using components from the car multimedia system and a cloud server, from the perspective of the car multimedia system; and

FIG. 8 shows a method for performing digital signal processing using components from the car multimedia system and the cloud server, from the perspective of the cloud server.

### DETAILED DESCRIPTION

Many modern motor vehicles are equipped with in-vehicle multimedia entertainment systems, such as radios and/or video players. The multimedia systems may output a plurality of signals accessible to the end user. Processing of these signals may allow for a diverse range of audio and/or video qualities to be adjusted in accordance with the user's preferences. The digital signal processing algorithms may include, for example, bass boosting, noise filtration, and other techniques. Vehicle multimedia systems may or may not include a broad library of digital signal processing features. In any case, the availability of digital processing features is generally fixed for a given car multimedia system, e.g. the collection of digital signal processing features may not be readily updatable by the user.

Some car multimedia systems may include a multitude of digital storage options, digital signal processing options, and/or video subsystems. Such systems may have the ability to provide advanced degrees of customization and tweaking, allowing the end user to perform fine adjustments to various qualities of audiovisual (AV) data. Digital signal processing may be implemented through the use of algorithms and computed on the digital signal processing units within the multimedia system itself. However, the selection available to users of such car multimedia systems is generally a fixed set of algorithms, oftentimes not updatable through software. Digital signal processing algorithms may also be licensed. Upon the creation of new or updated digital signal processing algorithms, many multimedia systems may not be able to implement the new or updated digital signal processing algorithms, due to memory and processing power limitations. Other car multimedia systems may include a relatively small selection of basic digital signal processing features, and may be equipped with only a small computational budget, meaning that complex digital processing features are unavailable due to processing power and memory limitations.

Thus, according to the embodiments described herein, one or more digital audio and/or video signals may be upstreamed to one or more remote computers (e.g., a cloud-based server/system), which may perform digital signal processing using one or more cloud-based digital processing algorithms in real time. The processed signals may be sent back to the multimedia entertainment system, allowing the processed signal to be played, for example, through the car's multitude of audio and/or video sinks (e.g. loudspeakers, screens, etc.). The digital signal processing services may be offered as part of a subscription service, allowing the user to select their preferred digital effects and optimizations. Furthermore, the available catalogue of effects may be updated as new algorithms are developed, allowing for users to effectively upgrade and customize their listening experience. In some embodiments, a network connection to a cloud-based digital signal processor may be routed through an external device, e.g. a mobile phone. With the external device acting as a sender and receiver, the digitally processed audio and/or video may in turn be transmitted to the car's multimedia system. This would allow virtually any car's multimedia system to (indirectly) connect to the cloud server, giving access to the cloud-based features on request to even very basic car multimedia systems.

Performing the signal processing algorithms on a cloud-based service allows for advanced digital signal processing tasks to be outsourced to a cloud server. The cloud-based service may perform extensive or complex computational tasks that are not performed on the car multimedia system itself. Processing of AV data via the cloud-based service may, however, demand a stable network connection to the server performing the cloud-based digital signal processing. A network connection may be established directly between the cloud server and the car multimedia system or through an intermediate device, such as a mobile phone with sufficient mobile connectivity, e.g. through 5G broadband mobile networking.

Mobile connectivity may be limited in some regions and may depend on factors such as the user's cell phone coverage. If network connections to the cloud-based digital signal processing servers are not feasible, the car's multimedia entertainment system may switch to one or more of its available on-board digital signal processing effects. Switching from one signal processing system to another abruptly may introduce undesirable audiovisual side-effects, such as pops, cracks, sudden changes in volume, and other effects. To mitigate the undesirable effects, a cross-morphing effect may be employed to ease the transition. As an example, cloud-processed audio data may be cached for a certain amount of time. If network coverage suddenly drops out, the drop in network coverage will be detected, then onboard digital signal processing may start and begin to fade in. Simultaneously, the digital signals received from the cloud may fade out. This technique implemented in the cross-fader may reduce or eliminate the above mentioned side-effects (e.g., pops, cracks, sudden changes in volume, etc.).

For full elimination of the above-mentioned side effects after activating one or more cloud-based features on demand, cross-morphing (as described above) may be insufficient. For example, if a particular cloud-based feature on demand contains a delay line (for example, a finite impulse response (FIR)-filter), or if it contains feedback (for example, an infinite impulse response (IIR)-filter), a sudden change of the signal after a period of silence will create a step response in the cloud signal, which may last longer than the cross-morphing period used when the network connection is lost. In some embodiments, different cross-morphing periods may be used when connections are dropped (e.g. a relatively short cross-morphing period may be applied when a connection is lost) relative to when the network connection is reestablished (e.g. a relatively long cross-morphing period may be applied when the connection is resumed). However, the variable cross-morphing periods may require an undesirably long time to complete (e.g. on the order of several seconds) until the transient effect (e.g. step signal) vanishes. In another embodiment, a cross-morpher may be inserted at the input of the signal processing feature (e.g., on the cloud), which may start cross-morphing in when the connection is established (e.g., the processed AV data processed on the cloud may be cross-morphed with unprocessed AV data at the cloud). With this approach choosing proper time to fade in will be the part of the feature. It will allow car multimedia system to always use the same cross-fading time without taking care on whether the selected time is enough or not.

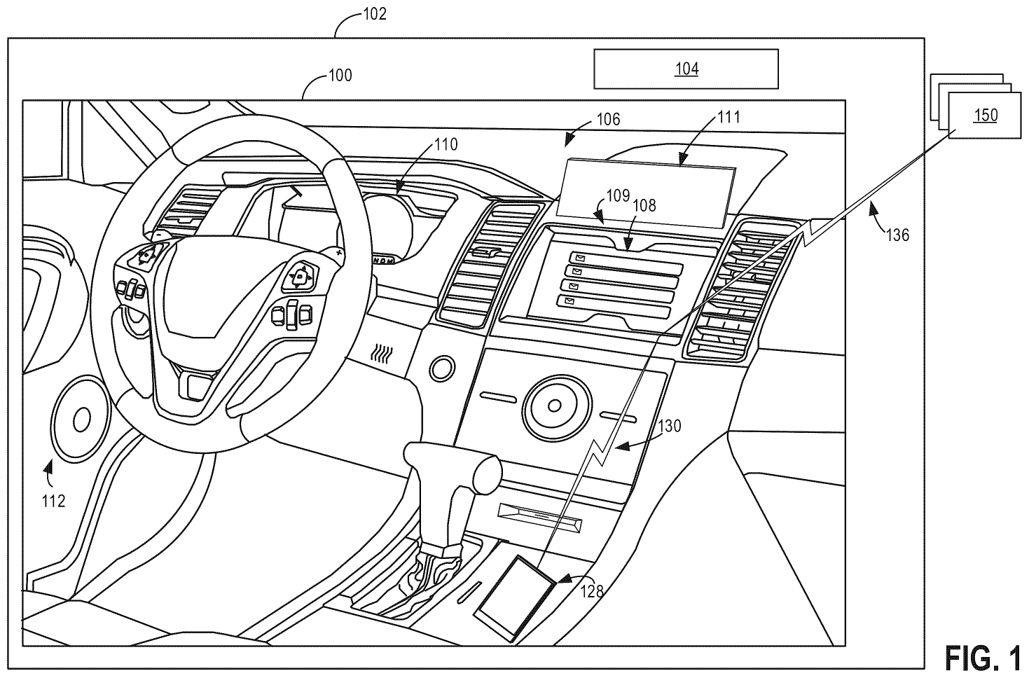

FIG. 1 shows an interior of a cabin 100 of a vehicle 102, in which a driver and/or one or more passengers may be seated. Vehicle 102 may be a road automobile, among other types of vehicles. In particular, vehicle 102 of FIG. 1 may be a motor vehicle including drive wheels (not shown) and an engine 104. In some examples, engine 104 may be an internal combustion engine. In other examples, engine 104 may be an electric engine, or may include hybrid components. For example, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

Vehicle 102 may include a plurality of vehicle systems, including a braking system for providing braking, an engine system for providing motive power to wheels of the vehicle, a steering system for adjusting a direction of the vehicle, a transmission system for controlling a gear selection for the engine, an exhaust system for processing exhaust gases, and the like. Further, the vehicle 102 includes an in-vehicle computing system 109.

As shown, an instrument panel 106 may include various displays and controls accessible to a human user (also referred to as the passenger) of vehicle 102. For example, instrument panel 106 may include a user input device such as a touch screen 108 of an in-vehicle computing system 109, an audio system control panel, a display 111, and an instrument cluster 110. Touch screen 108 may receive user input to the in-vehicle computing system 109 for controlling audio output, visual display output, user preferences, control parameter selection, etc.

Cabin 100 may also include one or more user objects, such as mobile device 128, that are stored in the vehicle before, during, and/or after travelling. The mobile device 128 may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct Near-Field Communication [NFC], cellular connectivity, etc.) and configured to provide two-way communication between the mobile device and the in-vehicle computing system. The mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 130 may provide sensor and/or control signals from various vehicle systems (such as vehicle audio system, sensor subsystem, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, GPS system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding navigational map data, image feature mapping data, etc. and may transmit such information from the external devices 150 to in-vehicle computing system 109 and/or touch screen 108.

In-vehicle computing system 109 may analyze the input received from external devices 150, mobile device 128, and/or other input sources and provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150. In some embodiments, the external devices 150 may include in-vehicle computing devices of another vehicle.

In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

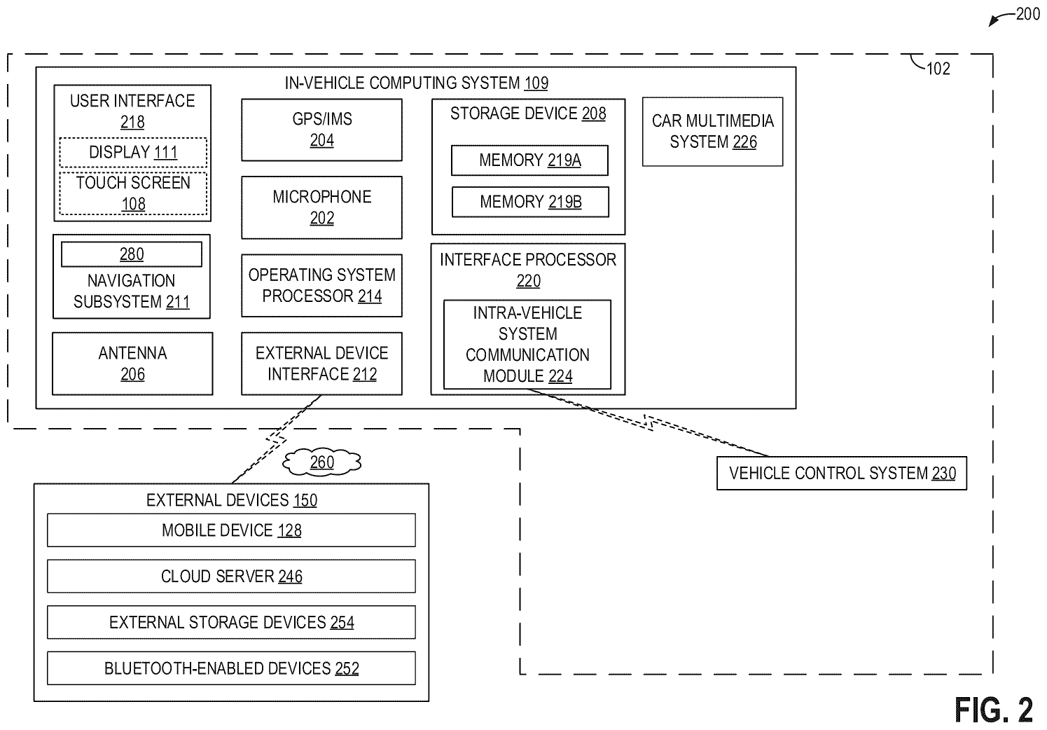

FIG. 2 shows a block diagram of an in-vehicle computing system 109 configured and/or integrated inside vehicle 102. In-vehicle computing system 109 may perform one or more of the methods described herein in some embodiments. The in-vehicle computing system may include, or be coupled to, various vehicle systems, sub-systems, hardware components, as well as software applications and systems that are integrated in, or integratable into, vehicle 102 in order to enhance an in-vehicle experience for a driver and/or a passenger. Further, the in-vehicle computing system may be coupled to systems for providing autonomous vehicle control.

In-vehicle computing system 109 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an intra-vehicle system communication module 224.

Intra-vehicle system communication module 224 may output data to vehicle control system 230, while also receiving data input from other vehicle components and systems, e.g. by way of vehicle control system 230. When outputting data, intra-vehicle system communication module 224 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System (GPS) sensors, Inertial Measurement System (IMS) etc.), digital signals propagated through vehicle data networks (such as an engine Controller Area Network (CAN) bus through which engine related information may be communicated, a climate control CAN bus through which climate control related information may be communicated, and a multimedia data network through which multimedia data is communicated between multimedia components in the vehicle). For example, vehicle data outputs may be output to vehicle control system 230, and vehicle control system 230 may adjust vehicle controls based on the vehicle data outputs. For example, the in-vehicle computing system 109 may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A storage device 208 may be included in in-vehicle computing system 109 to store data such as instructions executable by processors 214 and 220 in non-volatile form. The storage device 208 may store application data, including prerecorded sounds, to enable the in-vehicle computing system 109 to run an application for connecting to a cloud-based server and/or collecting information for transmission to the cloud-based server. The application may retrieve information gathered by vehicle systems/sensors, input devices (e.g., user interface 218), data stored in volatile memory 219A or non-volatile storage device (e.g., memory) 219B, devices in communication with the in-vehicle computing system (e.g., a mobile device connected via a Bluetooth link), etc. In-vehicle computing system 109 may further include a volatile memory 219A. Volatile memory 219A may be random access memory (RAM). Non-transitory storage devices, such as non-volatile storage device 208 and/or non-volatile memory 219B, may store instructions and/or code that, when executed by a processor (e.g., operating system processor 214 and/or interface processor 220), controls the in-vehicle computing system 109 to perform one or more of the actions described in the disclosure. The storage device 208 may also store audio and/or visual data to be used as sources for the car multimedia system 226.

A microphone 202 may be included in the in-vehicle computing system 200 to measure ambient noise in the vehicle, to measure ambient noise outside the vehicle, to review user input, etc. A navigation subsystem 211 of in-vehicle computing system 109 may generate and/or receive navigation information such as location information (e.g., via a GPS/IMS sensor 204 and/or other sensors from a sensor subsystem), route guidance, traffic information, point-of-interest (POI) identification, and/or provide other navigational services for the user. Navigation sub-system 211 may include inputs/outputs 280, including analog to digital converters, digital inputs, digital outputs, network outputs, radio frequency transmitting devices, etc. In some examples, navigation sub-system 211 may interface with vehicle control system 230.

External device interface 212 of in-vehicle computing system 109 may be coupleable to and/or communicate with one or more external devices 150 located external to vehicle 102. While the external devices are illustrated as being located external to vehicle 102, it is to be understood that they may be temporarily housed in vehicle 102, such as when the user is operating the external devices while operating vehicle 102. In other words, the external devices 150 are not integral to vehicle 102. The external devices 150 may include a mobile device 128 (e.g., connected via a Bluetooth, NFC, WIFI direct, or other wireless network connection) or alternate Bluetooth-enabled devices 252. Mobile device 128 may be a mobile phone, smart phone, wearable devices/sensors that may communicate with the in-vehicle computing system via wired and/or wireless communication, or other portable electronic device(s). The external devices 150 also include a cloud server 246 for performing remote processing of digital audio and/or video. In some embodiments, the network connection to the cloud server may be established through an intermediary, such as mobile device 128, for example. For example, the external devices may include extra-vehicular devices that are separate from and located externally to the vehicle. Still other external devices include external storage devices 254, such as solid-state drives, pen drives, USB drives, etc. External devices 150 may communicate with in-vehicle computing system 109 either wirelessly or via connectors without departing from the scope of this disclosure. For example, external devices 150 may communicate with in-vehicle computing system 109 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the user. For example, the external device interface 212 may enable voice calls to be established and/or text messages (e.g., SMS, MMS, etc.) to be sent (e.g., via a cellular communication network) to a mobile device 128 associated with a contact of the user. Further, in some examples, a vehicle user may adjust autonomous vehicle operation via an application of the mobile device 128 associated with the user. The external device interface 212 may additionally or alternatively provide a wireless communication interface to enable the in-vehicle computing system to synchronize data with one or more devices in the vehicle (e.g., the user's mobile device) via WIFI direct.

In-vehicle computing system 109 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via FR such as via antenna(s) 206 or via infrared or other means through appropriate receiving devices. For example, antenna 206 may receive voice calls (e.g., such as telephone calls). Additionally, antenna 206 may provide AM/FM radio signals to external devices 150 (such as to mobile device 128) via external device interface 212.

The intra-vehicle system communication module 224 may be communicatively coupled to a vehicle control system 230. The vehicle control system 230 may include, for example, an acceleration control, a braking control, and/or a steering control, in addition to numerous other controls, such as climate controls. The signals from the vehicle control system 230 may be used as inputs for digital signal processing. For example, the control signals may adjust audio output characteristics such as volume, equalization, audio image (e.g., the configuration of the audio signals to produce audio output that appears to a user to originate from one or more defined locations), audio distribution among a plurality of speakers, etc. In other examples, the control signals from the engine may be used for digital signal processing to synthesize engine noise, e.g. to enhance the sound of the engine through the use of the loudspeakers.

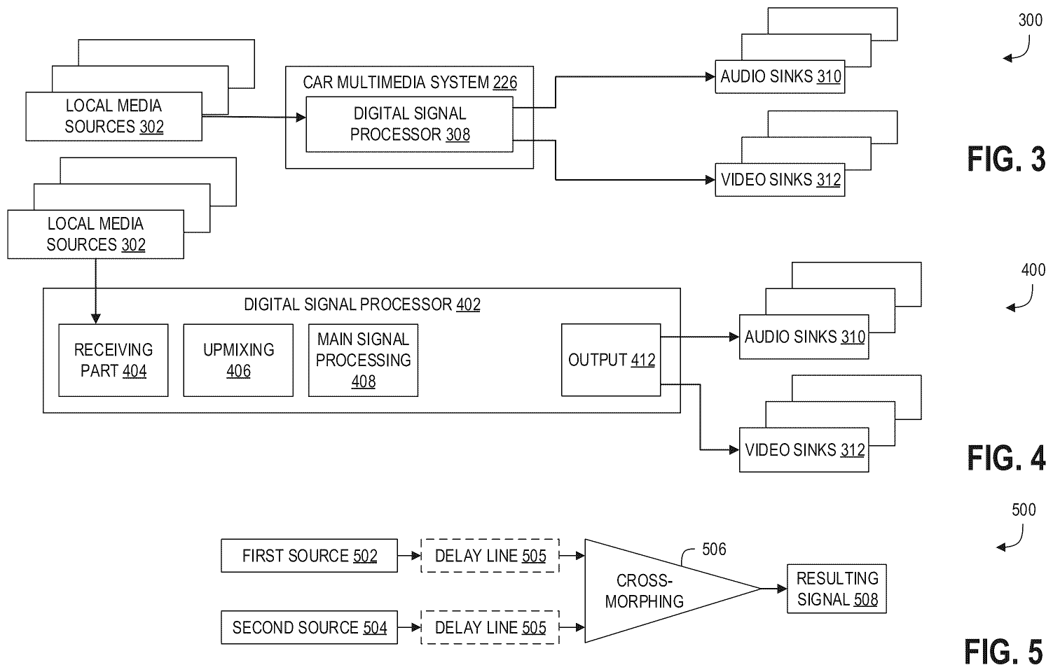

The in-vehicle computing system 109 may include a car multimedia system 226, which is configured for playing locally available and/or cloud-based media. The car multimedia system includes a digital signal processor for enhancing a quality of the audio and/or visual data. In addition, it may use external sources to perform some or all of the digital signal processing. For certain digital processing effects, the car multimedia system 226 may be communicatively coupled to the other sensors and sources of input within the in-vehicle computing system, such as the microphone 202. The car multimedia system 226 and its interaction with a cloud server is explained in further detail with respect to FIGS. 3-7. While the term “car multimedia system” is used herein, it is to be understood that the multimedia system 226 may be implemented in virtually any type of vehicle, including but not limited to cars, trucks, locomotives, heavy equipment (e.g., mine haul vehicles), etc.

FIG. 3 shows an example block diagram 300 of a typical vehicle AV system, including local media sources, sinks, and car multimedia system 226. The car multimedia system may take as input one or more local media sources 302. The local media sources may be, for example, music stored on one or more hard drives, mobile phones connected via Bluetooth, CDs, or virtually any other sources of audio, including audio stored in storage device 208, and may or may not also include video data, e.g. audiovisual (AV) data. The car multimedia system 226 may be coupled to one or more AV sinks, herein one or more audio sinks 310 and one or more video sinks 312, which may include a plurality of loudspeakers, radio antennas, and other input/output devices. The car multimedia system 226 may also include a head unit, which may serve as a user interface for the user to control the parameters of the audio playback, such as the volume, FM radio frequency, and media selection.

The car multimedia system 226 may also include a digital signal processor 308. The digital signal processor 308 may be capable of applying a set of effects available to the car multimedia system 226 itself, independent of cloud computation or internet connectivity. In the case of basic multimedia systems, the digital signal processor 308 may have access to only basic effects, e.g. simple equalization, bass boost, etc. Digital signal processing may be performed in several steps (e.g. receiving, upmixing, main signal processing, and output), as detailed with respect to FIG. 4 below.

The digital signal processor 308 processes the AV data from the local media sources using various methods. The digital signal processing methods employed may each process the AV data from one or more of the sources. For example, audio from two sources may be used to cross-morph between two songs played subsequently. As another example, the audio of a single source may be processed with a reverberation effect. The processed audio may be output to one or more audiovisual sinks, such as audio sinks 310 and/or video sinks 312. The audio sinks may be, for example, loudspeakers connected to the car multimedia system 226. Audio sinks may include speakers designed for various frequency ranges, such as subwoofers or mid-range speakers. The digital signal processor 308 may perform digital-to-analog conversion before the output is passed to the audio sinks. Amplification may also be employed to adjust the volume of the audio sinks' playback, as desired.

FIG. 4 shows a block diagram 400 of a digital signal processor 402. The digital signal processor 402 is an example of the digital signal processor 308 of the car multimedia system 226. The digital signal processor 402 includes a receiving part 404, which, in some embodiments, may be a digital buffer which loads part or all of a given piece of digital media, sourced from one or more local media sources 302. The digital signal processor 402 includes memory and one or more processors, which may vary in memory size and processing power, depending on the desired capabilities of the car multimedia system.

The digital signal processor 402 includes resources (e.g. memory and processing power) for performing upmixing 406. Upmixing, as described herein, refers to the process of mixing audio to increase the number of available audio channels. For example, given a digital audio source represented in stereo sound, upmixing may create an intermediate number of channels, e.g. front left, front right, back left, back right, and subwoofer. Digital audio channels generated in the intermediate upmixing process may be stored in volatile and/or nonvolatile memory, in a format usable for the main signal processing or transmissible to a cloud server for further processing.

The digital signal processor 402 includes resources to perform main signal processing 408. Main signal processing, as performed using the resources herein, may include the application of one or more digital audio effects to the AV data obtained from the local media sources, such as frequency-dependent filtering, noise filtration, bass boosting, and others. The main signal processing may perform a plurality of adjustments, including adjustments to surround sound. During the main signal processing 408, intermediate channels generated in the by upmixing 406 may be further split into specific speaker channels, whose number depends on the number of speakers in the system. Output generated by the main signal processing 408 may be stored in a digital buffer, usable for digital to analog conversion and/or cross-morphing.

The adjusted audio generated from the main signal processing 408 may be saved as output 412, e.g. in a buffer. To be usable as audio output, the digital signal generated by the main signal processing 408 may be converted to an analog signal. The analog signal may also be amplified or adjusted before being sent to one or more audio sinks 310 and/or video sinks 312 in the output 412.

It should be noted that the digital signal processor 402 may include more, fewer, or different components than illustrated in FIG. 4. In some embodiments, for example, upmixing 406 may be performed as part of the main signal processing 408. The internal components of the digital signal processor 402 may, in general, comprise executable instructions stored within volatile and/or nonvolatile memory and executable using one or more digital processor(s) within the digital signal processor.

FIG. 5 shows a block diagram 500 for cross-morphing audio and/or video from two sources: a first source 502 and a second source 504. For example, the first source may be a local digital signal processor and the second source may be a cloud-based digital signal processor. Cross-morphing may be performed by the digital signal processor 402 using memory and processing resources thereon. Cross-morphing, as used herein, is the process of fading audio and/or video from the first source 502 to the second source 504 (or vice versa). The two AV data sources may be buffered audio and/or video stored in memory, such as the buffer of the main signal processing 408. The sources are input into a cross-morpher 506 for cross-morphing. The cross-morpher 506 performs three tasks simultaneously: gradually adjusting (e.g., lowering) the volume of the first source 502, gradually adjusting (e.g., raising) the volume of the second source 504, and adding the adjusted signals (e.g., with the raised and lowered volumes) together to form a resulting signal 508 as its output. Cross-morphing is advantageous compared to simply switching between the sources of AV data because cross-morphing minimizes audio effects associated with abrupt switching, such as pops and clicks. Cross-morphing is usable in the current disclosure to fade between audio processed on a cloud-based digital signal processor and a local digital signal processor. In the event that the cloud-based digital signal processor cannot be reached, the output from the local digital signal processor may fade in smoothly, allowing for a less noticeable transition in the event of a network connection drop. To enable the transition from AV data processed by the cloud-based digital signal processor to the locally-processed version of the AV data, the AV data processed by the cloud-based digital signal processor may be buffered for a sufficient amount of time using memory available to the local digital signal processor. Depending on the digital signal processing feature in use on the cloud server, this buffer may comprise, as a non-limiting example, 6 to 20 milliseconds of audio.

Furthermore, to allow for the first source 502 and second source 504 to be appropriately synchronized in time, a delay line 505 may be introduced on either the first or second source. The delay line 505 acts to delay the signal of one of the sources (relative to the other), adjustable such that the two source signals are aligned in time. The delay line 505 is an optional component of the cross-morpher and may not be included if computational resources are unavailable.

The cross-morphing performed by the cross-morpher 506 may be configurable by the user through a variety of different parameters. For example, the period of the cross-morph (e.g. the amount of time it takes to transition from the first source 502 and the second source 504) may be adjusted. As an example, the cross-morphing may have a default period of 10 milliseconds. Other adjustments may include adjusting how the AV data sources' volume is increased and decreased. The volume of the input sources may be increased and decreased linearly in time, for example. In other examples, the cross-morphing may be performed approximately exponentially in time. Settings related to the cross-morphing may be adjustable by the user and/or manufacturer of the car multimedia system.

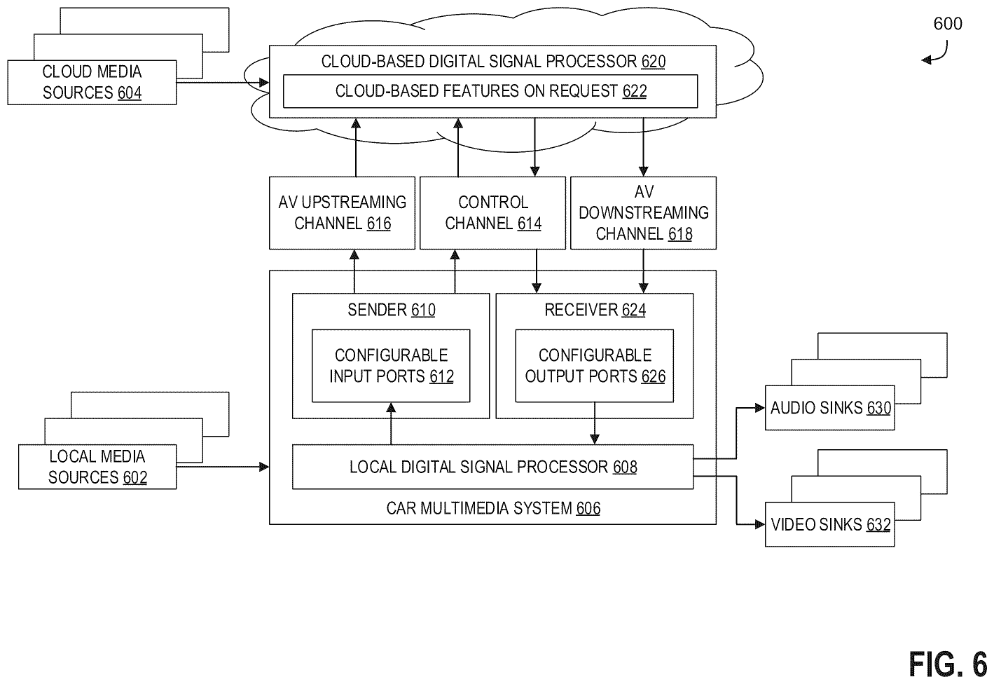

FIG. 6 shows a block diagram 600 containing a car multimedia system 606 and a cloud-based digital signal processor 620. The car multimedia system 606 includes interfaces for sending and receiving data to and from the cloud. Car multimedia system 606 is a non-limiting example of (e.g., an extended version of) the car multimedia system 226 of FIG. 3, which may be configured to play digital audio and/or video from a number of sources, e.g. local media sources 602. As explained with respect to FIGS. 3-5, the car multimedia system is configurable to produce output on one or more audiovisual sinks, such as audio sinks 630 and/or the video sinks 632 through the use of its local digital signal processor 608, which is a non-limiting example of (e.g., an extension of) the digital signal processor 402 (see FIG. 4). The local digital signal processor 608 both processes the local media sources 602 and takes AV data as input from the cloud-based digital signal processor 620, which, as described below, generates digitally processed results using its own resources. The car multimedia system 606 further includes resources configurable to perform cross-morphing, as described above with respect to FIG. 5. Cross-morphing, as used by the car multimedia system 606, is usable to cross-morph from a local version of digitally processed AV data and a cloud-based version of digitally processed AV data.

The local media sources 602 may be input directly into a car multimedia system 606, and may be passed by into a local digital signal processor 608 (e.g. into its receiving part, which may include a buffer, as explained with respect to the receiving part 404 of the digital signal processor 402 of FIG. 4). The local digital signal processor 608 is configurable to perform a number of adjustments to the local media sources 602, such as upmixing and main digital signal processing. Output of the main digital signal processing may be buffered in memory to allow for cross-morphing to another source of audio, such as audio sourced by the cloud digital signal processor.

Block diagram 600 includes a cloud-based digital signal processor 620 configurable to receive at least a portion of a digital audiovisual file from the car multimedia system 606 and/or from one or more cloud media sources 604. The cloud-based digital signal processor 620 is configurable to perform similar operations to the local digital signal processor, such as upmixing, main digital signal processing, and output. The cloud-based digital signal processor may include a greater collection of computing resources, such as processing power and memory, than the car multimedia system. When a network connection to the cloud-based digital signal processor 620 can be successfully established, the cloud-based digital signal processor 620 may process the audiovisual data in parallel to the local digital signal processor 608. The cloud-based digital signal processor 620 includes a second, larger set of AV digital signal processing features than the car multimedia system, referred to as cloud-based features on request 622, which can be applied to perform computationally-difficult digital signal processing algorithms, which include, but are not limited to, complex reverberations which simulate a large space (e.g. a cathedral), adapting the audio playback based on external weather conditions and the level of noise, changing the filtering options depending on the genre of music of the sources, simulating more acoustic space within the vehicle, various surround and immersion effects, virtual speakers, virtual bass (for vehicles without a subwoofer), engine sound synthesis, add-on standard acoustic vehicle alerting system (AVAS) for hybrid and electric cars, automatic equalization and measurement of the car, including sound balancing depending on number and/or position of passengers, speed dependent volume control, synchronized audio and video streams, improved audio/video flow, and more. If combinable, several on demand audio/video features can be requested by the same user in parallel, for example, advanced AVAS sounds and surround effects. To perform processing of the local media sources 602, the local digital signal processor 608 may send partially-processed audiovisual data. Partially-processed data may be sourced directly from the receiving part of the local digital signal processor 608. In other examples, the local digital signal processor may perform upmixing on the local media sources 602 before sending them to the cloud-based digital signal processor.

Once the cloud-based digital signal processor 620 has processed the digital signals (e.g. through its own main digital signal processing) received from the local digital signal processor 608, the cloud-based digital signal processor 620 may send the processed digital signals back to the local digital signal processor 608, where usable output for the audio and/or video sinks may be generated through, for example digital to analog conversion. In this way, the main digital signal processing may be outsourced to the cloud-based digital signal processor 620. The output from the cloud-based digital signal processor may also be saved (e.g. buffered) on the local digital signal processor 608, which allows for cross-morphing in the event of network connection drop and/or network connection reestablishment. For example, if the connection between the cloud-based digital signal processor 620 and the car multimedia system 606 drops, the local digital signal processor 608 may cross-morph to buffered audio and/or video generated through processing by the local digital signal processor 608 itself. At least a short-term AV buffer (e.g. comprising 20-30 milliseconds of AV data) may be included as part of the local digital signal processor 608 to store data received from the cloud-based digital signal processor. In some examples, such as when the media source is a broadcast media source (e.g., Internet radio station), the AV data processed on the cloud-based digital signal processor may be processed in hyper-real time (e.g., faster than the playback time of the AV data) and sent to the car multimedia system, which may allow a short amount of the processed AV data to be saved in the buffer for cross-morphing.

In addition to the local media sources 602, AV data from one or more cloud media sources 604 may be input into the cloud-based digital signal processor 620. The cloud media sources 604 may be stored on a cloud server, accessible to the cloud-based digital signal processor 620. In the case that one or more cloud media sources 604 are used, all digital signal processing of the cloud media sources 604 may be performed by the cloud-based digital signal processor 620. The processed audio and/or video data may be sent to the local digital signal processor 608 for output to the audio sinks 630 and/or video sinks 632 (e.g. using digital to analog conversion).

To facilitate communication with a cloud-based digital signal processor 620, car multimedia system may include a sender 610 and a receiver 624. As will be described in more detail below, the local digital signal processor 608 may send and/or receive AV data to and from a cloud-based digital signal processor 620. Data sent to the cloud-based digital signal processor 620 may comprise the AV data from one or more local media sources 602. The AV data from the local media sources 602 may include audio and/or visual components and may or may not be partially processed through methods implemented on the local digital signal processor 608. Data received by the local digital signal processor 608 through the receiver may comprise audio and/or visual sources processed using the cloud-based digital signal processor 620. The sender 610 and the receiver 624 are both communicatively coupled to the cloud-based digital signal processor 620 via a sufficiently fast communication protocol, e.g. 5G broadband mobile networking. Communicative coupling may be achieved through three channels: an AV upstreaming channel 616 (for transmitting audiovisual data from the sender to the cloud server), an AV downstreaming channel 618 (for transmitting the audiovisual data from the cloud server to the receiver), and a control channel 614 (to transmit instructions, requests, and other information, such as sensor data, between the sender, cloud server, and receiver).

The sender 610 is configured for sending user requests via the control channel 614 and for transmitting audiovisual data via the AV upstreaming channel 616. The sender may send AV data received through one or more configurable input ports 612 connected to the local digital signal processor 608. The configurable input ports 612 may be configured to receive one or more sources, some of which may be partially or completely processed audio and/or video from the local media sources 602 and stored in one or more dedicated buffers in memory. To accomplish this, the configurable input ports may receive data from the local digital signal processor 608 from several different intermediate stages of processing. For example, the configurable input ports 612 may directly receive the data from the buffer of the receiving part 404 of the local digital signal processor 608. In another example, upmixing 406 may be performed on the local digital signal processor 608 before being sent to the sender via the configurable input ports 612. In both of the previous examples, the main signal processing 408 may be outsourced to the cloud-based digital signal processor 620, performed using one or more compatible cloud-based features on request 622. In order to choose which cloud-based features should be used, the sender 610 may request a list of available features and transmit the user's selection of compatible features.

Cloud-based features on request are configurable to be either dependent on or agnostic to the configuration of the vehicle (e.g., car) at which the processed signals will ultimately be output for playback. For example, adding a reverberation effect to the AV data does not consider the configuration of the vehicle, e.g. how many output channels the vehicle has, the type, placement, and/or number of loudspeakers, or other parameters. Other features may be dependent on the configuration of the vehicle and/or its loudspeakers. For example, surround sound effects will depend on the number of speakers, their types, positions, their position and/or proximity relative to the driver and/or passengers, etc. Thus, although the same digital signal processing feature may be used in a variety of different cases, fine tuning may depend on the configuration of the vehicle and/or its multimedia system.

The configurable input ports 612 may also include data from sensors within the motor vehicle. For example, a microphone (e.g. microphone 202) may be configured to pick up engine noise for input in one or more digital signal processing algorithms. In other examples, digital and/or analog signals from the vehicle control system 230 may be used for signal enhancement. For example, the sender 610 may take as input a noise profile of the vehicle's engine, then broadcast the engine noise data via the control channel 614. Using one or more cloud-based features on request 622, audio from the local media sources 602 and/or the cloud media sources 604 may be adjusted based on the engine noise sample, e.g. by selectively boosting frequency components of the digital audio associated with frequency components of the engine noise. In this example, the configurable input ports 612 may be adjusted, e.g. depending on the positioning of the microphone and/or the type of engine within the vehicle. In a similar way, other configurable input ports 612 may apply cloud-based digital signal processing based on input from sensors.

The receiver 624 is configurable for receiving information from the AV downstreaming channel 618 and receiving data from the control channel 614. The AV downstreaming channel 618 may provide audio and/or video data processed via the cloud-based features on request 622, which may originate from either the local media sources 602 and/or the cloud media sources 604.

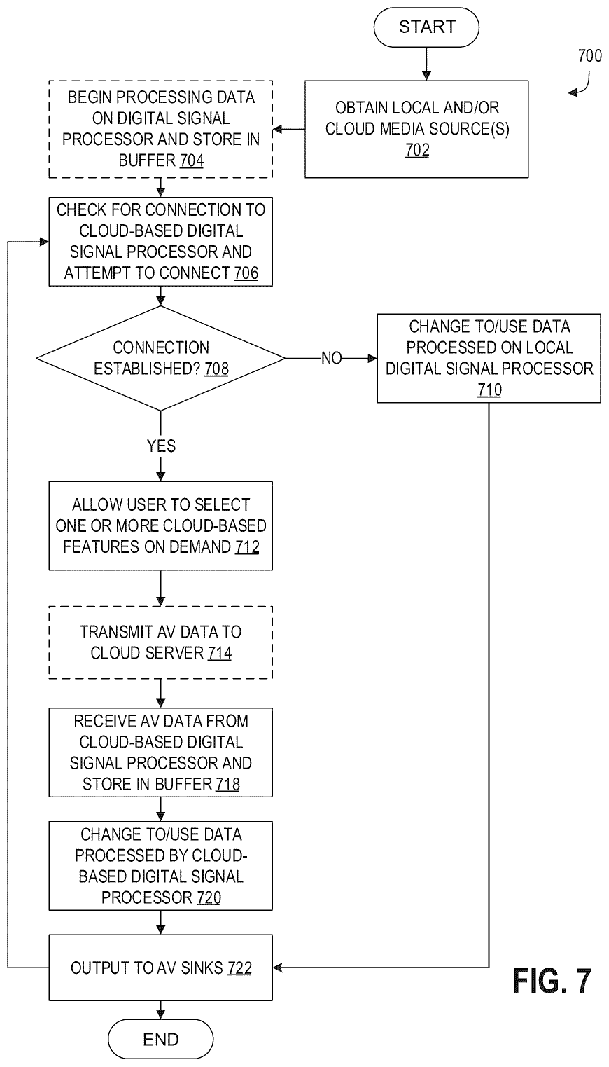

Receiver 624 is equipped with configurable output ports 626, which allow for data to be transmitted to the local digital signal processor 608. The processed data collected by the receiver 624 may be output, using one or more configurable output ports 626, into the local digital signal processor 608, which may perform some further processing, such as compressors, limiters, cross-morphing, for example. Cross-morphing may be performed to shift from audiovisual data generated by the cloud-based digital signal processor 620 to the audiovisual data generated by the local digital signal processor 608 in the event of network connection drop and/or reestablishment, as explained in more detail with respect to FIG. 7.

The resulting output, which may be sourced from a combination of the local digital signal processor's output and the data collected from the receiver 624, may be passed into one or more audio sinks 630 and/or video sinks 632 via an output signal generated by the local digital signal processor 608, e.g. through digital to analog conversion. For example, analog to digital conversion may be used to play audio on one or more loudspeakers. Output may also be transmitted to other audio sinks 630 or video sinks 632, such as mobile phones connected (e.g. through Bluetooth, USB, etc.) to the car multimedia system 606.

Data received from the control channel 614 may comprise a list of available cloud features on request 622. The cloud features listed for the given user may depend on several factors, including a user's subscriptions plan or the compatibility of the features. For example, some filters may not be usable together (e.g. if they are inverses of each other). Cloud-based features on request 622 may include a variety of filters requiring a high degree of computational complexity and memory, e.g. a complex reverberation effect designed to mimic the acoustics of a cathedral.

As mentioned above, some cloud-based features on request may be vehicle-agnostic, while the others are dependent on the configuration of the vehicle and the car multimedia system. Vehicle-agnostic features may not receive, process, and/or output digital signals on physical channels when a network connection is established, but may utilize logical channels, for example, 7.1 as target buffers (e.g. when the feature is reverb or a surround algorithm writing the data to 7.1 buffers). Having received requests for abstract source/target buffers, the car multimedia system may translate the received processed digital signals locally to physical audio/video buffers corresponding to the requested logical audio/video buffers. Support of this mechanism assumes agreement between features on demand manufacturers or even standardization in referencing logical channels. One advantage of vehicle-agnostic features is easy maintenance and a wider range of potential users as it is suitable not just for the given audio/video system of a specific car model, but for wide family of audio systems. However, not all features can be car-agnostic, and thus some processing features applied by the cloud-based digital signal processor may result in processed signals being received by the car multimedia system with physical channels specified (e.g., physical AV buffers).

FIG. 7 shows an example method 700 for processing audiovisual data using a system including a vehicle multimedia system in communication with a cloud-based digital signal processor, such as the system illustrated by block diagram 600 and described above. Method 700 may be executed using instructions stored on memory of a vehicle multimedia system, such as in-vehicle computing system 109 and/or the car multimedia system 606, in combination with instructions stored in memory of a remote service, such as the cloud-based digital signal processor 620. Method 700 generates output usable in one or more AV sinks, such as audio sinks 630 and/or video sinks 632 as non-limiting examples. AV sinks, as discussed in the context of method 700, may further include, for example, one or more other audio channels to be processed using locally-available digital signal processing features. At 702, method 700 includes obtaining one or more AV data files (also referred to as digital media files) from one or more local and/or cloud media sources. The local media sources may comprise, for example, digital media files stored within the car multimedia system and/or one or more external devices communicatively coupled to the car multimedia system, including, but not limited to, hard drives, navigation systems, and/or mobile phones. The cloud media sources may be accessible to, or stored on, a cloud server, communicatively coupled to the cloud-based digital signal processor, such as cloud media sources 604. The AV data file(s) from the media source(s) may be obtained in response to a user request to listen and/or view the digital media files and/or automatically in response to the car multimedia system being activated (e.g., following a vehicle startup), a navigation prompt or car alert being issued, or another event (e.g., the AV data files may be pushed to the car multimedia system via a mobile phone).

If an AV data file is locally available (e.g., obtained from a local media source), at 704, method 700 may begin processing the audiovisual data within the AV data file through methods available to a local digital signal processor of the car multimedia system, such as the local digital signal processor 608. The local digital signal processor may receive the audiovisual data of the AV data file from the local media source(s), perform upmixing, and perform the main signal processing to create a locally processed version of the AV data using one or more locally available processing features, which may comprise a first, smaller set of processing features. As explained above with respect to FIG. 4, the AV data from the local media source(s) may be upmixed in order to form multiple channels of AV data, which are configured to be output to respective different speakers, for example. The main signal processing may include processing the (upmixed) AV data to allow for surround sound or other lower processing demand audio features. The results of the main signal processing may be stored within a buffer of the car multimedia system. The contents of the buffer (e.g., a buffered signal) may be used in the event of a network connection drop with the cloud-based digital signal processor, as will be explained in more detail below. The local digital signal processor may include limited features compared to the cloud server. The audiovisual data processed in intermediate steps, such as the AV data after upmixing, is also usable to be sent (e.g. via an AV upstreaming channel) to the cloud-based digital signal processor. In this way, when the AV data file is sourced from a local media source, the car multimedia system may pre-process the AV data of the AV data file the local digital signal processor of the vehicle, where the pre-processing may include forming a plurality of digital AV signals (e.g., corresponding to the multiple channels described above) from the AV data file and saving the plurality of digital AV signals in a buffer (e.g., in an input buffer, such as receiving part 404 or in another buffer of the local digital signal processor).

At 706, method 700 includes checking for a network connection to the cloud-based digital signal processor and attempting to connect to the cloud-based digital signal processor. As described with respect to block diagram 600 above, the network connection may be established through an AV upstreaming channel, AV downstreaming channel, and a control channel.

If a network connection with the cloud-based digital signal processor cannot be established, method 700 proceeds to 710, which includes changing to/using the AV data processed on the local digital signal processor. In the case of a first attempted network connection not being established, the local digital signal processor's processed audiovisual data may be used, such that method 700 proceeds to 722, wherein the audiovisual data (that is processed with the local digital signal processor of the car multimedia system) is output to one or more AV sinks (e.g., one or more loudspeakers and/or display screens). The processing performed by the local digital signal processor may include additional processing beyond the processing described above (e.g., additional processing beyond forming the different channels, such as applying local processing features). Outputting to the AV sinks may include performing digital to analog conversion, as demanded for some types of output, such as loudspeakers. Thus, when a network connection with the cloud-based digital signal processor cannot be established, the AV data processed by the local digital signal processor may be output to the one or more AV sinks (e.g., speakers) using only digital signal processing features available to the local digital signal processor, e.g. without the use of digital signal processing features available to the cloud-based digital signal processor.

If instead at 708 a network connection is established with the cloud-based digital signal processor, method 700 proceeds to 712, which includes allowing the user to select one or more cloud-based features on request. Allowing the user to select one or more cloud-based features on request may comprise receiving a list of available cloud-based features on request (such as the cloud-based features on request 622 explained above) from the cloud, using a control channel (such as control channel 614). Through interactions with a user interface, a user may select one or more features of the cloud-based features on request displayed via the user interface, for example. An indication of the requested features (e.g., the features selected by the user) may be sent through the control channel to the cloud-based digital signal processor, where the requested features may be used to process the digital audiovisual data. If features have already been selected by the user, method 700 may instead skip to 714. Further, in some examples, vehicle-specific system/playback features may also be sent the cloud-based digital signal processor, such as loudspeaker configuration (e.g., type, size, position, etc.) and locally-available processing features.

The features selected by the user at 712 may be checked against each other for compatibility. For example, features may be deemed incompatible with each other if they utilize overlapping resources. In one example, two digital signal processing features may use the same buffer for audio processing, potentially creating undesired effects by allowing one processing feature to overwrite the AV data of another. Feature compatibility may be checked by the car multimedia system and/or the cloud sever. If one or more features are incompatible, the user may be notified at 712 and prompted to select compatible features.

At 714, the AV data is transmitted to the cloud server. For example, an AV upstreaming channel may be used to transmit the AV data to the cloud server. If the media source for the AV data is a cloud media source, the AV data does not need to be transmitted from the local digital signal processor, since the source is already accessible to the cloud-based digital signal processor. However, if the media source for the AV data is a local media source, the AV data is transmitted to the cloud-based digital signal processor at 714. Transmitting the AV data may comprise transmitting partially processed (e.g., the plurality of digital AV signals generated from the pre-processing described above, which may correspond to the different channels as described above) or unprocessed data via the AV upstreaming channel. In some examples, as explained previously, the local digital signal processor may perform upmixing, such that the AV data that is transmitted to the cloud server via the AV upstreaming channel is pre-processed (e.g., upmixed) AV data. In other examples, upmixing is not performed using the local digital signal processor and the AV data that is transmitted to the cloud server may not be pre-processed.

In some examples, the AV data that is transmitted to the cloud server may be selected based on the processing features selected by the user. For example, the cloud server may send a request to the car multimedia system indicating what AV data (e.g., which of the plurality of digital AV signals) to send to the cloud server and the car multimedia system may send the requested AV data. In some examples, the cloud server may request that all the AV data be sent. In other examples, the cloud server may request that only a portion of the AV data be sent, such as only a portion of the digital AV signals (e.g., only the channels demanded for the selected processing feature(s)).

At 718, method 700 includes receiving processed AV data from the cloud server and saving the received processed AV data in a buffer (e.g., an output buffer, such as output 412). The processed AV data may be received through an AV downstreaming channel. The processed AV data saved in the buffer may be used, for example, cross-morph to or from the cloud-processed audiovisual data. At 720, method 700 includes changing to or using the AV data processed by the cloud server. If a network connection to the cloud server was established successfully, the AV data processed by the cloud-based digital signal processor may be used as the output source. If the network connection remains stable, method 700 may continue playback of the cloud-processed AV data without any cross-morphing or changes in the source of the processed AV data. If playback of AV data is currently ongoing with output from the local digital signal processor, cross-morphing may be performed at 720 in order to cross-morph into the audiovisual data processed at the cloud-based digital signal processor and received at 718. Method 700 then proceeds to 722 to output the processed AV data to one or more AV sinks, using the AV data processed by the cloud server as output. In some examples, the cloud-based digital signal processor may send AV data to the local digital signal processor to undergo further digital signal processing, e.g. through one or more features available to the local digital signal processor, before the processed AV data is output to the one or more AV sinks.

In some examples, as explained above, only some of the channels (e.g., digital signals) of the AV data may be processed by the cloud-based digital signal processor. In such examples, the channels/digital signals received from the cloud server may be output to the appropriate AV sink(s) and the remaining locally processed channels/digital signals (e.g., not sent to or received from the cloud server) may be output to the appropriate AV sink(s).

Method 700 continuously checks for an active network connection to the cloud-based digital signal processor. When AV output is generated and sent to the AV sinks at 722, method 700 loops back to 706, which checks that the network connection to the cloud server is maintained (e.g. the connection continues to allow transmission and reception of AV data and control information).

Dropped network connections or corrupted network connections may be detected through a variety of means. If the AV data is transmitted via packets, an internal system clock of the multimedia system may determine the time between the two most recently-received packets. If the time between the two most recent packets is above some threshold, method 700 may determine that the network connection has been lost. Additionally, a dropped or corrupted network connection may be detected through the use of a checksum, which may be any of a variety of cryptographic methods usable to determine the completeness of a given packet of data. The checksum method employed by the car multimedia system may depend on the communication protocol used to establish the network connection to the cloud-based digital signal processor. If the checksum determines that sufficiently many packets are complete, the car multimedia system determines that the network connection is stable and uncorrupted.

If the network connection is maintained method 700 proceeds to 712 to continue to send the AV data to the cloud server and receive the processed AV data from the cloud server for playback. Otherwise, for example if the previously-established network connection is dropped, method 700 proceeds to 710, where data processed on the local digital signal processor may be used. Using the data processed on the local digital signal processor may be accomplished, for example, by cross-morphing to the buffered AV data saved by the local digital signal processor and proceeding to 722. Because the processed AV data received from the cloud server is saved in a buffer (e.g., 10 milliseconds or more worth of data) prior to being output to the AV sinks, the processed AV data in the buffer may be cross-morphed with the AV data that is processed locally with the car multimedia system for a short amount of time before only AV data that is processed locally is output. Thus, method 700 switches between using the cloud-based AV output and the local digital signal processor's output, based on the availability of the cloud-based AV output. If desired, for example if the user turns the vehicle off or otherwise halts playback, method 700 may end instead of looping back to 706.

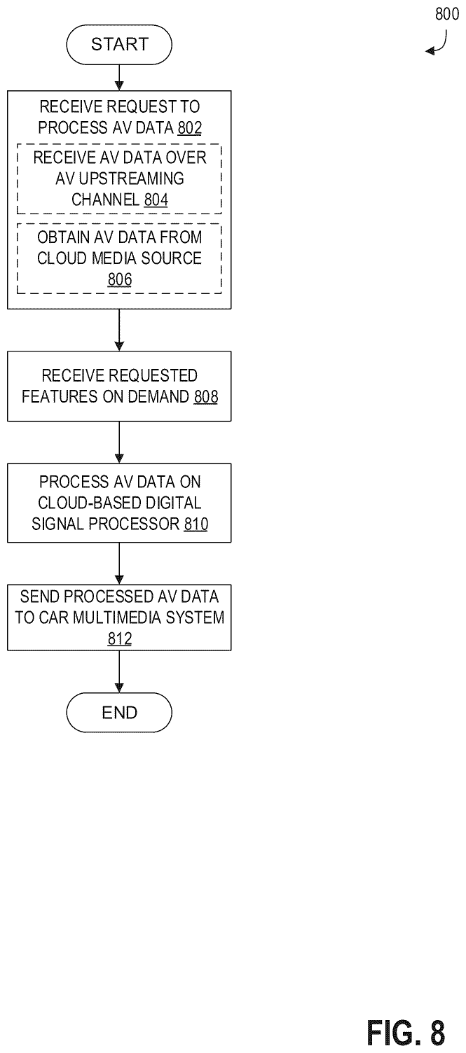

FIG. 8 shows an example method 800 for processing audiovisual data using a system including a vehicle multimedia system in communication with a cloud-based digital signal processor, such as the system illustrated by block diagram 600 and described above. Method 800 may be executed using instructions stored in memory of a remote service, such as the cloud-based digital signal processor 620 residing on a cloud-based server (also referred to as a cloud server).

At 802, method 800 includes receiving a request to processes AV data. The request may be received, for example, through a control channel established between a car multimedia system and the cloud-based digital signal processor. Receiving a request to process AV data further includes, at 804, receiving AV data over an AV upstreaming channel, such as the AV upstreaming channel 616. Receiving the AV data over the AV upstreaming channel may comprise receiving AV data from the car multimedia system, which is configurable to obtain the AV data from one or more local media sources. Additionally, or alternatively, at 806, receiving a request to process AV data further includes obtaining data from one or more cloud media sources, such as the cloud media sources 604. The cloud media sources may comprise, for example, music available from a streaming service communicatively coupled to the cloud-based digital signal processor.

At 808, method 800 receives the requested features on demand from the user. Requests may be transmitted via the control channel. The features requested from the user through the control channel may comprise a number of digital signal processing features, such as the cloud-based features on request 622. The user's requests are saved in the memory of the cloud-based digital signal processor. Before receiving the requested features on demand, the cloud-based digital signal processor may transmit a list of available features via the control channel. Further, in some examples, based on the requested processing features, the cloud server may send a request to the car multimedia system indicating which aspects of the AV data to send to the cloud server for processing, e.g., which pre-processed digital AV signals to send. The compatibility of digital signal processing features may be checked by the car multimedia system at 808, as described further at 712 of FIG. 7, and if the requested features are not compatible, the cloud-based digital signal processor may send a notification to the car multimedia system indicating the features are not compatible.

At 810, method 800 includes processing the AV data on the cloud-based digital signal processor. The AV data processed at 810 is the AV data obtained at 802, and may therefore be received from one or more cloud media sources and/or local media sources. Data received via the AV upstreaming channel (e.g. obtained at 806) may be or may not have been partially processed (e.g. upmixed) by the local digital signal processor of the car multimedia system. If the received audio is not upmixed, upmixing may be performed by the cloud-based digital signal processor at 810. Whether or not the received data was upmixed, main digital signal processing may be performed by the cloud-based digital signal processor at 810, using one or more processing features requested by the user at 808. These features may include, for example, effects not available to the local digital signal processor itself, e.g. reverberation and frequency-filtering effects too computationally intensive for the local digital signal processor. Computationally intensive digital processing effects include, but are not limited to, virtual bass, virtual speakers, advanced surround sound processing, adaptive equalization, and more.

At 812, method 800 includes sending processed AV data to the car multimedia system. The processed AV data may be sent, for example, through an AV downstreaming channel, such as AV downstreaming channel 618. Method 800 ends.

The technical effect of outsourcing the main signal processing to a cloud-based digital signal processor is that premium signal processing features otherwise unavailable to the user become available through a networking connection. Another technical effect is that new signal processing features may be added to the cloud-based digital signal processor or existing signal processing features of the cloud-based digital signal processor may be adjusted without having to update the local digital signal processor of each vehicle, which may reduce network traffic and memory and processing demands of each vehicle's multimedia system.

In another representation, a method for on demand processing of audiovisual (AV) data includes receiving, from a multimedia system of a vehicle, a request to apply one or more selected processing features to a selected AV data file, obtaining AV data corresponding to the selected AV data file, applying, with a cloud-based digital signal processor, the one or more selected processing features to the AV data to form a set of cloud-processed digital AV signals, and sending the set of cloud-processed digital AV signals to the multimedia system of the vehicle. In a first example of the method, obtaining the AV data corresponding to the selected AV data file comprises receiving the AV data from the multimedia system of the vehicle. In a second example of the method, optionally including the first example, obtaining the AV data corresponding to the selected AV data file comprises receiving the AV data from a cloud-based AV source. In a third example of the method, optionally including one or both of the first and second examples, the AV data corresponding to the selected AV data file comprises one or more digital AV signals pre-processed by a local digital signal processor of the multimedia system. In a fourth example of the method, optionally including one or more or each of the first through third examples, the one or more selected processing features comprise one or more of surround sound, immersion effects, reverberations, virtual speakers, virtual bass, and adaptive equalization. In a fifth example of the method, optionally including one or more or each of the first through fourth examples, the method further includes determining a multimedia configuration of the vehicle and applying the one or more selected processing features to the AV data based on the multimedia configuration. In a sixth example of the method, optionally including one or more or each of the first through fifth examples, the multimedia configuration of the vehicle includes one or more of a number of speakers in the vehicle, a position of each speaker in the vehicle, and a type of each speaker in the vehicle. In a seventh example of the method, optionally including one or more or each of the first through sixth examples, the method further includes determining that the one or more selected processing features are not dependent on a multimedia configuration of the vehicle and applying the one or more selected processing features to the AV data without determining the multimedia configuration of the vehicle. In an eighth example of the method, optionally including one or more or each of the first through seventh examples, obtaining the AV data corresponding to the selected AV data file comprises receiving the AV data from a broadcast media source, and wherein applying the one or more selected processing features to the AV data to form the set of cloud-processed digital AV signals comprises performing hyper-processing to apply the one or more selected processed features to the AV data at a rate faster than a playback rate of the AV data. In a ninth example of the method, optionally including one or more or each of the first through eight examples, applying the one or more selected processing features to the AV data to form the set of cloud-processed digital AV signals comprises cross-morphing the set of cloud-processed digital AV signals with the AV data for a threshold duration based on the one or more selected processing features.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the car multimedia system 226 described with reference to FIG. 2. The methods may be performed by executing stored instructions with one or more logic devices (e.g., processors) in combination with one or more additional hardware elements, such as storage devices, memory, hardware network interfaces/antennae, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method for on-demand audiovisual (AV) data processing for playback in a vehicle, comprising:
pre-processing, with a local digital signal processor of the vehicle, an AV data file, the pre-processing including forming a plurality of digital AV signals from the AV data file;
sending at least a portion of the plurality of digital AV signals to a cloud-based server configured to apply one or more processing features to the at least the portion of the plurality of digital AV signals;
receiving processed versions of the at least the portion of the plurality of digital AV signals from the cloud-based server; and
outputting the processed versions of the at least the portion of the plurality of digital AV signals to one or more AV sinks of the vehicle.

2. The method of claim 1, wherein sending at least the portion of the plurality of digital AV signals to the cloud-based server comprises receiving, from the cloud-based server, a request indicating which of the plurality of digital AV signals to send to the cloud-based server and sending the at least the portion of the plurality of digital AV signals to the cloud-based server in response to the request.

3. The method of claim 2, further comprising sending, to the cloud-based server, an indication of the one or more processing features to be applied to the at least the portion of the plurality of digital AV signals, and wherein the cloud-based server is configured to determine which of the plurality of digital AV signals to request based on the one or more processing features to be applied.

4. The method of claim 1, wherein the plurality of digital AV signals is stored in a first buffer and further comprising saving the processed versions of the at least the portion of the plurality of digital AV signals in a second buffer.

5. The method of claim 4, further comprising determining that a network connection to the cloud-based server has been lost, and in response, cross-morphing the processed versions of the at least the portion of the plurality of digital AV signals saved in the second buffer with locally processed versions of the at least the portion of the plurality of digital AV signals, the locally processed versions of the at least the portion of the plurality of digital AV signals processed by the local digital signal processor.

6. The method of claim 5, further comprising determining that the network connection to the cloud-based server has been restored, and in response, cross-morphing the processed versions of the at least the portion of the plurality of digital AV signals received from the cloud-based server after the network connection is restored with locally processed versions of the at least the portion of the plurality of digital AV signals.

7. The method of claim 1, wherein only the portion of the plurality of digital AV signals are sent to the cloud-based server and processed versions of only the portion of the plurality of digital AV signals are received from the cloud-based server, and further comprising outputting a remainder of the plurality of digital AV signals along with the processed versions of only the portion of the plurality of digital AV signals to the one or more AV sinks.

8. The method of claim 1, wherein the AV data file is obtained from a local media source positioned in the vehicle.

9. The method of claim 1, wherein the AV data file comprises an audio file and the one or more AV sinks comprise one or more speakers of the vehicle, and wherein the one or more processing features applied to the at least the portion of the plurality of digital AV signals comprise one or more of surround sound, immersion effects, reverberations, virtual speakers, virtual bass, and adaptive equalization.

10. A multimedia system for a vehicle, comprising:
a digital signal processor comprising an input buffer configured to receive an audiovisual (AV) data file, an upmixer configured to pre-process the AV data file to form a plurality of digital AV signals, a main signal processor configured to apply a first, smaller set of processing features to the plurality of digital AV signals, and an output buffer;
a sender configured to send the AV data file in the input buffer or one or more of the plurality of digital AV signals from the upmixer to a cloud server, the cloud server configured to apply a second, larger set of processing features to the AV data file or the plurality of digital AV signals to form a set of cloud-processed digital AV signals;
a receiver configured to receive the set of cloud-processed digital AV signals; and
one or more AV sinks configured to output the set of cloud-processed digital AV signals for playback.

11. The multimedia system of claim 10, wherein the AV data file comprises an audio file and the one or more AV sinks comprise one or more speakers of the vehicle, and wherein the second, larger set of processing features comprise one or more of surround sound, immersion effects, reverberations, virtual speakers, virtual bass, and adaptive equalization.

12. The multimedia system of claim 10, wherein the AV data file is obtained from a local media source positioned in the vehicle.

13. The multimedia system of claim 12, wherein the local media source comprises a mobile phone, and wherein the sender is configured to send the AV data file in the input buffer or one or more of the plurality of digital AV signals from the upmixer to the cloud server via the mobile phone.

14. The multimedia system of claim 10, further comprising a cross-morpher configured to, in response to a determination that a network connection to the cloud server has been lost, cross-morph the set of cloud-processed digital AV signals with locally processed versions of the digital AV signals, the locally processed versions of the digital AV signals processed by the digital signal processor.

15. The multimedia system of claim 10, wherein the receiver is configured to translate a requested abstract target buffer received with the set of cloud-processed digital AV signals to one or more physical buffers corresponding to the requested abstract target buffer and send the set of cloud-processed digital AV signals to the one or more AV sinks according to the one or more physical buffers.
